(19) United States
(12) Patent Application Publication
(10) Pub. No.: US 2016/0170493 A1
(43) Pub. Date: Jun. 16, 2016

(54) GESTURE RECOGNITION METHOD IN VEHICLE USING WEARABLE DEVICE AND VEHICLE FOR CARRYING OUT THE SAME

(71) Applicant: Hyundai Motor Company, Seoul (KR)

(72) Inventor: Un Kyu Park, Seoul (KR)

(21) Appl. No.: 14/751,868

(22) Filed: Jun. 26, 2015

(30) Foreign Application Priority Data
Dec. 15, 2014 (KR) 10-2014-0180527

(51) Int. Cl. G06F 3/01; G06F 3/00; G05D 1/00; G06F 1/16

(52) U.S. Cl. CPC G06F 3/017; G06F 1/163; G06F 3/002; G05D 1/0016

(57) ABSTRACT

A method and system for enabling a vehicle to recognize a gesture of a driver using a wearable device and executing a function that corresponds to the recognized gesture is provided. The gesture recognition method in a vehicle includes performing a wireless connection with a wearable device, and receiving gesture information sensed by the wearable device from the connected wearable device. In addition, a function that corresponds to the received gesture information, and is determined to execute the function.

### CROSS REFERENCE TO RELATED APPLICATION(S)

This application claims the benefit of Korean Patent Application No. 10-2014-0180527, filed on Dec. 15, 2014, which is hereby incorporated by reference as if fully set forth herein.

### BACKGROUND

1. Field of the Invention

The present invention relates to a method for enabling a vehicle to recognize a driver gesture using a wearable device and for executing a function that corresponds to the recognized gesture and a vehicle for carrying out the same.

2. Discussion of the Related Art

In general, technologies have been developed to recognize motion of a specific part of a user body, i.e. a gesture, using imaging devices or various sensors such as, proximity sensors, to receive the recognized gesture as a user command. Current technology includes sensors that recognize a user gesture involving a foot to open a trunk of a vehicle when a user moves their foot under the trunk.

However, in the above-described method sensors must be installed in every gesture recognition location and the use of proximity sensors and imaging device sensors causes a restricted recognition area or performance deterioration due to sensor occlusion by foreign substances.

### SUMMARY

Accordingly, the present invention provides a gesture recognition method in a vehicle using a wearable device and a vehicle for carrying out the same and further provides a method for efficiently recognizing a gesture of a driver to implement various functions and an apparatus for carrying out the same.

To achieve these objects and other advantages and in accordance with the purpose of the invention, as embodied and broadly described herein, a gesture recognition method in a vehicle may include performing wireless connection with a wearable device, receiving gesture information sensed by the wearable device from the connected wearable device, determining a function that corresponds to the received gesture information, and executing the determined function.

In accordance with another aspect of the present invention, an in-vehicle gesture recognition system configured to recognize a gesture via a wearable device may include a wireless communication unit connected to the wearable device to receive gesture information sensed by the wearable device, a wired communication unit configured to communicate with other controllers of the vehicle, and a controller configured to determine a function that corresponds to the received gesture information and to execute the wired communication unit to transmit an execution command to a controller for execution of the determined function, thereby allowing the corresponding controller to execute of the determined function.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary view illustrating a gesture and a body region on which a wearable device to sense the gesture is worn according to exemplary embodiments of the present invention;

FIGS. 2A-2C are exemplary views illustrating wearable devices applicable to exemplary embodiments of the present invention;

FIG. 3 is an exemplary view illustrating a recognition area according to an exemplary embodiment of the present invention;

FIG. 4 is an exemplary flowchart illustrating an exemplary process of executing a function corresponding to a gesture sensed in a vehicle using a wearable device according to an exemplary embodiment of the present invention; and

FIG. 5 is an exemplary block diagram illustrating an exemplary configuration of an in-vehicle gesture recognition system capable of implementing a gesture recognition operation according to an exemplary embodiment of the present invention.

### DETAILED DESCRIPTION OF THE INVENTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, In order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

It is understood that the term “vehicle” or “vehicular” or other similar term as used herein is inclusive of motor vehicle in general such as passenger automobiles including sports utlity vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

Although an exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as a non-transitory computer readable media on a computer readable medium containing executable program instructions executed by a processor, controller/control unit or the like. Examples of the computer readable mediums include, but are not limited to, ROM, RAM, Compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Hereinafter, exemplary embodiments of the present disclosure will be described with reference to the accompanying drawings. However, the drawings to be described below and the following detailed description relate to one exemplary embodiment of various exemplary embodiments for effectively explaining the characteristics of the present invention. Therefore, the present invention should not be construed as being limited to the drawings and the following description.

Further, in the following exemplary embodiments, the terminologies are appropriately changed, combined, or divided so that those skilled in the art may clearly understand them, in order to efficiently explain the main technical characteristics of the present invention, but the present invention is not limited thereto.

In an embodiment of the present invention a gesture may be input through a wearable device worn by a vehicle passenger and a vehicle may be configured to detect the input gesture upon wirelessly receiving information regarding the gesture to execute a function that corresponds to the recognized gesture. The wearable device may be worn on the user's arm or hand, and the vehicle may be configured to sense whether the wearer is located within or extraneous to the vehicle using the intensity of a wireless signal from the wearable device (received signal strength indication e.g., RSSI). In addition, upon sensing that the wearer is located (e.g., the subject with the wearable device) within the vehicle, the vehicle may be configured to determine whether the wearer is a driver to provide the driver and a passenger with different functions. A determination method for this will be described below in further detail.

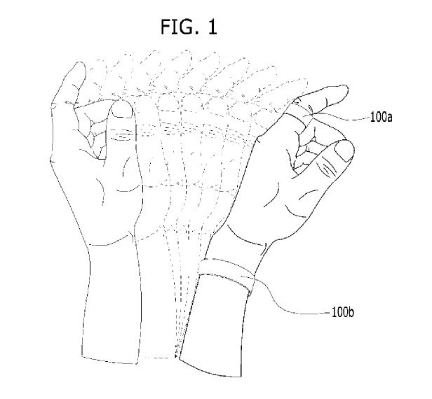

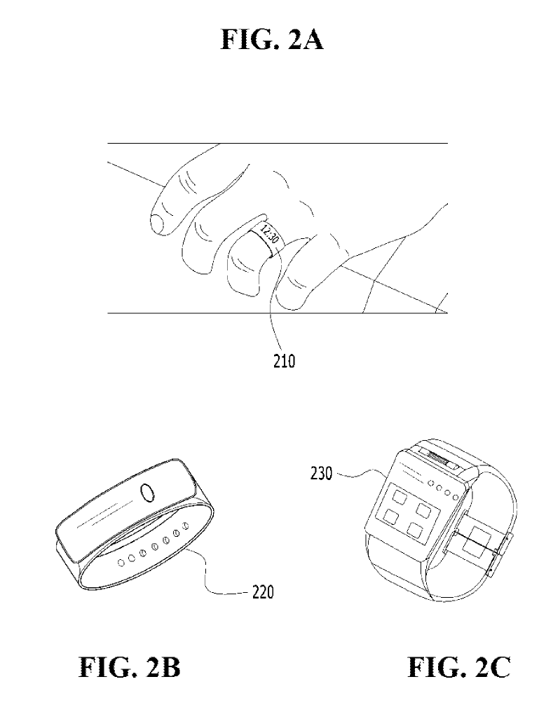

FIGS. 1 and 2A-2C are exemplary embodiments of a gesture and a wearable device used to sense the gesture. FIG. 1 is a view illustrating a gesture and a body region where a wearable device to sense the gesture may be (e.g., attached) worn. As described above, a gesture may be input via the hand. As shown in FIG. 1, to sense motion of a hand, a wearable device 100a may be worn on the finger alternatively, a wearable device 100b may be worn (e.g. attached in any known manner) on the wrist.

FIGS. 2A-2C illustrate the wearable devices. As shown in FIG. 2A a wearable device designed to be worn on the finger may be a smart ring 210. As shown in FIG. 2B, a wearable device designed to be worn on the wrist may be a smart bracelet 220 or a smart watch 230 as shown in FIG. 2C.

The types of the wearable devices illustrated in FIGS. 2A-2C are given by way of example and the present invention should not be limited thereto and any other types of wearable devices may be used so long as they are worn on, for example, the arm, the finger and the wrist to sense a gesture of the wearer and to wirelessly transmit the sensed gesture to the vehicle (e.g., a vehicle controller). Accordingly, each of the wearable devices may include at least a motion sensing module and a wireless communication unit. For example, the motion sensing module may include a gyro sensor and an accelerometer. The wireless communication unit may support at least Bluetooth technology or Wi-Fi technology.

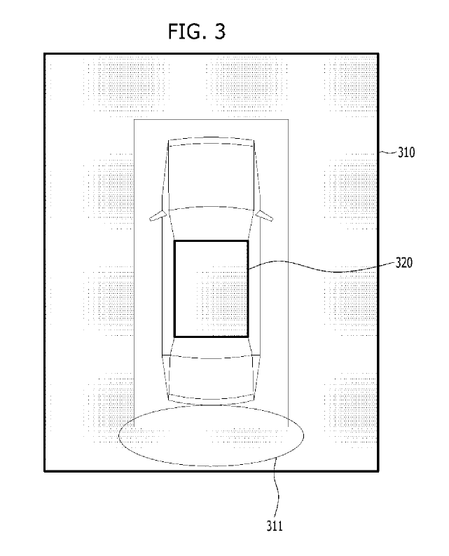

As described above, in the present invention, a controller of the vehicle may configured to set a recognition area to sense whether a wearer of the wearable device is located in an extraneous to the vehicle or in an within the vehicle. FIG. 3 is an exemplary view illustrating a recognition area according to an embodiment of the present invention. Referring to FIG. 3, an exterior recognition area 310 may be set within a given exterior range from the vehicle. Accordingly, when a user wearing any one of the wearable devices 210 to 230 approaches the vehicle, the vehicle controller may be configured to sense, based on the intensity of a signal from the wearable device, that the wearable device is located in the exterior recognition area 310. The vehicle controller may be configured to request the wearable device for transmission of information related to a gesture sensed by the wearable device. Conversely, when the vehicle controller senses that the wearable device deviates from the exterior recognition area 310, the vehicle controller may be configured to request that the wearable device no longer transmit sensed gesture information, which may aid in reduction of power consumption in the wearable device.

Furthermore, an additional exterior recognition area 311 may be set at a trunk portion of the vehicle and may be used to determine whether to open or close a trunk according to a gesture input while the wearable device is sensed in the corresponding area. In addition, when the wearable device is sensed in an interior recognition area 320, (e.g., within the vehicle) recognition to distinguish between a driver and a passenger may be implemented. In particular, driver or passenger recognition may be performed by grasping a feature of gesture sensed by the wearable device and determining whether a wearer of the wearable device is driving the vehicle or is disposed within the vehicle. For example, when the vehicle senses a steering wheel operation or a transmission control motion and thereafter the wearable device senses a gesture that corresponds to the motion or operation, the vehicle controller may be configured to determine that the corresponding wearable device is worn by a driver.

In response to determining that the wearer of the wearable device is a driver, the vehicle controller may be configured to permit only functions, which do not cause dispersion of attention, to be implemented in response to a gesture. When the vehicle controller determines that wearer is not a driver, the vehicle may provide all functions that may be executed via a gesture.

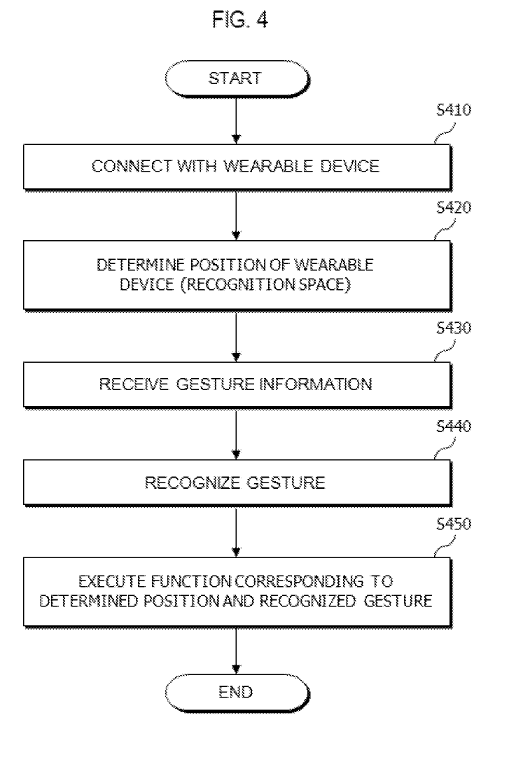

FIG. 4 illustrates an exemplary function execution process based on gesture recognition. In particular, FIG. 4, a flowchart illustrates an exemplary process of executing a function that corresponds to a gesture sensed in the vehicle through the wearable device. Referring to FIG. 4, the vehicle and the wearable device may be connected S410. The vehicle may be connected to the wearable device, and a vehicle controller may be configured to measure the intensity of a wireless signal received from the wearable device to determine a position of the wearable device, for example, whether the wearable device is within a recognition space and whether the wearable device is within any one of the interior or exterior recognition spaces S420. When the wearable device is present in the recognition space, the vehicle controller may be configured to request information from the wearable device related to a sensed gesture. As a result, the wearable device may be configured to activate a motion sensing module and, upon sensing a gesture, information related to the sensed gesture may be transmitted to the vehicle controller. The vehicle may receive the transmitted information S430.

The information related to the gesture, (i.e. gesture information) may include information related to a sensed heading, time, and speed. The vehicle controller may be configured to compare the gesture information with a plurality of gesture patterns preset based on a per recognition space basis. A pattern may be recognized that may correspond to the received gesture information based on a comparison result S440. For example, when the wearable device is located in an exterior recognition space and a gesture has a pattern of holding out the arm and again pulling the arm toward the body by a given distance, the vehicle controller may be configured to recognize this gesture as a door open command. In another example, when the wearable device is present in an exterior space and a gesture has a pattern of holding out and raising the arm, the vehicle controller may be configured to recognize this gesture as a trunk open command. Once the recognition space and the gesture are recognized, the vehicle controller may be configured to execute a corresponding function 5450. Furthermore, when the recognition space is an interior space, the vehicle controller may be configured to determine whether the wearable device is attached to a driver and limit a function to be implemented based on gesture recognition.

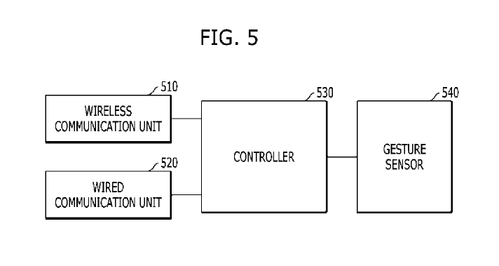

Hereinafter, a device configuration to implement the above-described embodiments will be described. An exemplary configuration of an in-vehicle gesture recognition system to implement the above-described functions is illustrated in FIG. 5. In particular, FIG. 5 is an exemplary block diagram illustrating an exemplary configuration of an in-vehicle gesture recognition system capable of implementing a gesture recognition operation. Referring to FIG. 5, the in-vehicle gesture recognition system may include a wireless communication unit 510 connected to the wearable device to exchange various control signals and gesture information via wireless communication protocols for example, Bluetooth or Wi-Fi. A wired communication unit 520 may be connected to transmit an execution command to a controller that may implement a function that corresponds to a recognized gesture or to receive an operational status of each vehicle component to determine whether the wearer is a driver based on pattern comparison. The controller 530 may be configured to operate the above-described components and to implement the determination and calculation required for implementation of the present exemplary embodiment. For example, the controller 530 may be configured to operate the wireless communication unit 510 to implement wireless connection with the wearable device, determine a recognition area where the wearable device is located using the intensity of a signal received from the connected wearable device, and recognize the received gesture information to transmit an execution command to a corresponding controller via the wired communication unit to enable implementation of a function that corresponds to the recognized gesture information.

Further, general gesture sensors 540 may be installed within the vehicle and extraneous to the vehicle. The wired communication unit 520 may support at least one communication standard selected from CAN, CAN FD, FlexRay, Lin, and Ethernet. It will be clearly understood by those skilled in the art that the configuration of FIG. 5 is given by way of example and a different number of constituent elements may be provided. For example, the wireless communication unit may be present in an AVN system of a vehicle configured to execute a telematics function or a hands-free function.

The above-described gesture recognition system may provide enhanced convenience and reduced cost. In particular, as compared to camera-based gesture recognition, in-vehicle gesture recognition may be implemented without mounting additional sensors and a gesture recognition area may be expanded to the exterior of a vehicle. As a result, for example, a function of locking a door after parking or a function of storing a parked location may be implemented via a gesture. There are no requirements for additional sensors since a wearable device worn by a passenger is configured to recognize a gesture. In addition, different functions may be performed according to whether a wearer of the wearable device is a driver and according to a recognition area.

The present invention as described above may be implemented as a computer readable code of a computer readable medium in which programs are recorded. The computer readable medium includes all kinds of recording devices in which data that may be read by a computer system is stored. Examples of the computer readable medium may include a hard disk drive (HDD), a solid state disk (SSD), a silicon disk drive (SDD), ROM, a RAM, a CD-ROM, a magnetic tape, a floppy disk, and an optical data storage device. In addition, the computer readable recording medium includes a carrier wave (e.g., data transmission over the Internet).

While this disclosure has been described in connection with what is presently considered to be practical exemplary embodiments, it is to be understood that the present disclosure is not limited to the disclosed exemplary embodiments but on the contrary, is intended to cover various modifications and equivalent arrangements included within the spirit and scope of the accompanying claims. In addition, it is to be considered that all of these modifications and alterations fall within the scope of the present disclosure.

What is claimed is:

1. A gesture recognition method in a vehicle, the method comprising:
performing, by a controller, wireless connection with a wearable device;
receiving, by a the controller, gesture information sensed by the wearable device from the connected wearable device;
determining, by the controller a function that corresponds to the received gesture information; and
executing by the controller the determined function.

2. The method according to claim 1, further comprising:
determining, by the controller a position of the wearable device,
wherein the determination of the function is implemented based on the determined position.

3. The method according to claim 2, wherein the position of the wearable device includes an interior recognition area of the vehicle and an exterior recognition area of the vehicle.

4. The method according to claim 3, further comprising:
requesting, by the controller, the wearable device for transmission of the gesture information in response to determining that the position of the wearable device is within the interior recognition area or the exterior recognition area.

5. The method according to claim 3, further comprising:
comparing, by the controller the gesture information with an operating pattern of a steering wheel or a transmission of the vehicle in response to determining that the position of the wearable device is within the interior recognition area,
wherein at least some functions are restricted when the gesture information corresponds to the operating pattern.

6. The method according to claim 1, wherein the wearable device is worn on a wrist or a finger.

7. The method according to claim 1, wherein the wearable device includes any one selected from the group consisting of: a smart ring, a smart bracelet, and a smart watch.

8. The method according to claim 1, wherein the gesture information includes at least one selected from the group consisting of: a direction, a time, and a speed of a gesture sensed by the wearable device.

9. An in-vehicle gesture recognition system configured to recognize a gesture via a wearable device, the system comprising:
a wireless communication unit connected wireless to the wearable device to receive gesture information sensed by the wearable device;
a wired communication unit configured to communicate with a plurality of vehicle component controllers; and
a vehicle controller configured to determine a function that corresponds to the received gesture information and to operate the wired communication unit to transmit an execution command to a vehicle component controller for execution of the determined function.

10. The system according to claim 9, wherein the controller is configured to determine a position of the wearable device from the intensity of a signal received from the wearable device and to determine a function that corresponds to the gesture information using the determined position.

11. The system according to claim 10, wherein the position of the wearable device includes an interior recognition area of the vehicle and an exterior recognition area of the vehicle.

12. The system according to claim 11, wherein the controller is configured to request the wearable device for transmission of the gesture information in response determining that the position of the wearable device is within the interior recognition area or the exterior recognition area.

13. The system according to claim 11, wherein the controller is configured to compare the gesture information with an operating pattern of a steering wheel or a transmission of the vehicle acquired via the wired communication unit in response to determining that the position of the wearable device is within the interior recognition area and to restrict execution of at least some functions when the gesture information corresponds to the operating pattern.

14. The system according to claim 9, wherein the wearable device is worn on a wrist or a finger.

15. The system according to claim 9, wherein the wearable device includes any one selected from the group consisting of: a smart ring, a smart bracelet, and a smart watch.

16. The system according to claim 9, wherein the gesture information includes any one selected from the group consisting of: at least one of a direction, a time, or a speed of a gesture sensed by the wearable device.

17. A non-transitory computer readable medium containing program instructions executed by a controller, the computer readable medium comprising:
program instructions that perform, by a controller, wireless connection with a wearable device;
program instructions that receive, by a the controller, gesture information sensed by the wearable device from the connected wearable device;
program instructions that determine, by the controller a function that corresponds to the received gesture information; and
program instructions that execute by the controller the determined function.
